(19) United States
(12) Patent Application Publication
(10) Pub. No.: US 2010/0079871 A1
(43) Pub. Date: Apr. 1, 2010

(54) Reflective surfaces capable of displaying different images under various lighting conditions

(76) Inventor: Thomas G. Malzbender, Palo Alto, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/286,481

(22) Filed: Sep. 30, 2008

(51) Int. Cl. G02B 27/10; G03B 25/02

(52) U.S. Cl. 359/627; 40/454

(57) ABSTRACT

Embodiments of the present invention relate to reflective surfaces. In one embodiment, a reflective surface comprises a substrate and multiple light-reflecting features disposed on the substrate. One or more images reflected from the multiple features can be produced by selectively covering at least portions of select features with a light absorbing material. Each image can be separately viewed by varying an observer's point of observation or each image can be viewed from a fixed observation point by varying the direction incident light impinges the surface.

### TECHNICAL FIELD

Embodiments of the present invention relate generally to reflective surfaces that display a different image under different lighting conditions.

### BACKGROUND

Photographs are typically used to convey an image of a real scene, object, or occurrence. However, a photograph only conveys a single image of what may be a variable scene. Lenticular prints have been developed as an alternative medium for conveying more than a single image. A lenticular print is a medium in which a lenticular lens is used to produce images with an illusion of depth or to convey movement as the image is viewed from different angles. Examples of lenticular prints show flip and animation effects such as printed words or graphics that change their message or image depending on the viewing angle. Lenticular prints were orignially used as novelty items but are more recently being used as a marketing tool to show objects in motion.

Lenticular printing is a multi-step process consisting of creating a lenticular image from at least two existing images, and combining the images with a lenticular lens. Each image is sliced into strips which are then interlaced. These interlaced images can be printed on the backs of a lenticular lenses. The lenses are lined up with each image interlace, so that light reflected off each strip is refracted in a slightly different direction, but the light from all strips of a given image are sent in the same parallel direction. The end result is that a single eye or camera looking at the print sees a single whole image, but an eye or camera with a different viewing angle sees a different image. This process can be used to create various frames of animation for a motion picture effect, offsetting the various layers at different increments for a three-dimensional effect, or simply to show a set of alternate images which may appear to transform into each other. When more images are used and taken in a sequence, a short motion picture can be produced.

However, lenticular prints are limited to only allowing an observer to view the contents of each image from particular corresponding obseration points. It is desireable to have a surface configured to display multiple images that can not only be viewed separately from different observation points but can also be viewed from one observation point under various viewing conditions.

### SUMMARY

Embodiments of the present invention relate to reflective surfaces. In one embodiment, a reflective surface comprises a substrate and multiple light-reflecting features disposed on the substrate. One or more images reflected from the multiple features can be produced by selectively covering at least portions of select features with a light absorbing material. Each image can be separately viewed by varying an observer's point of observation or each image can be viewed from a fixed observation point by varying the direction incident light impinges the surface.

### BRIEF DESCRIPTION OF THE DRAWINGS

FIG. 1 shows a front-view of a reflective surface configured in accordance with embodiments of the present invention.

FIGS. 2A-2B show isometric and cross-sectional views, respectively, of a convex feature configured in accordance with embodiments of the present invention.

FIGS. 3A-3B show isometric and cross-sectional views, respectively, of a concave feature configured in accordance with embodiments of the present invention.

FIGS. 4A-4E show cross-sectional views of a partially painted convex feature operated in accordance with embodiments of the present invention.

FIGS. 5A-5E show cross-sectional views of a partially painted concave feature operated in accordance with embodiments of the present invention.

FIGS. 6A-6D show how a reflective surface can be painted to create the appearance of an object changing position in accordance with embodiments of the present invention.

FIGS. 7A-7D show how dithering can be applied to a reflective surface to create the appearance of a three-dimensional image in accordance with embodiments of the present invention.

FIGS. 8A-8D show how a grey-scale of paint can be applied to a reflective surface to create the perception of a three-dimensional image in accordance with embodiments of the present invention.

FIG. 9 shows a front view of multiple features of a full-color reflective surface configured in accordance with embodiments of the present invention.

FIG. 10 shows painted blue and green features of the multiple features 900 in accordance with embodiments of the present invention.

FIGS. 11A-11C show multiple features selectively painted to reflect yellow light for light incident from a first direction and reflect red light for light incident from a second direction in accordance with embodiments of the present invention.

FIGS. 12A-12C shows multiple features selectively painted to reflect violet light for light incident from a first direction and reflect orange light for light incident from a second direction in accordance with embodiments of the present invention.

FIG. 13 shows examples of a full-color reflective surface configured to produce a color change, movement, or color change and movement in accordance with embodiments of the present invention.

### DETAILED DESCRIPTION

Embodiments of the present invention relate to reflective surfaces that can produce one or more images. Unlike lenticular prints, a reflective surface can be configured so that each image can be viewed separately without varying an observer's point of observation by varying the direction light impinges on the reflective surface, or the reflectance surface can be illuminated so that the observer can view each image by varying the observer's point of observation.

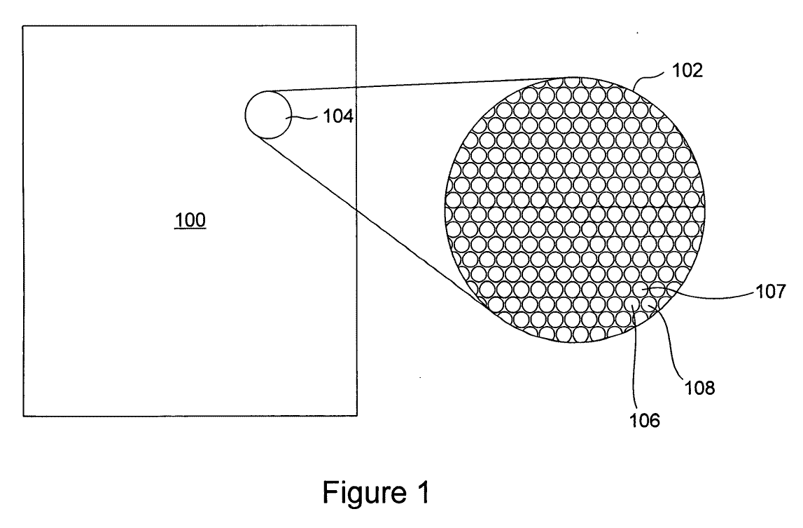

FIG. 1 shows a front-view of a reflective surface 100 configured in accordance with embodiments of the present invention. The reflective surface 100 is blank. In other words, no image is painted or printed on the reflective surface 100. FIG. 1 includes a magnified view 102 of a portion 104 of the reflective surface 100. The magnified view 102 reveals a tightly-packed, two-dimensional array of multiple features, such as feature 106. The smallest repeating unit or “unit cell” of the array of features is a triad of features, such as triad of features 106-108.

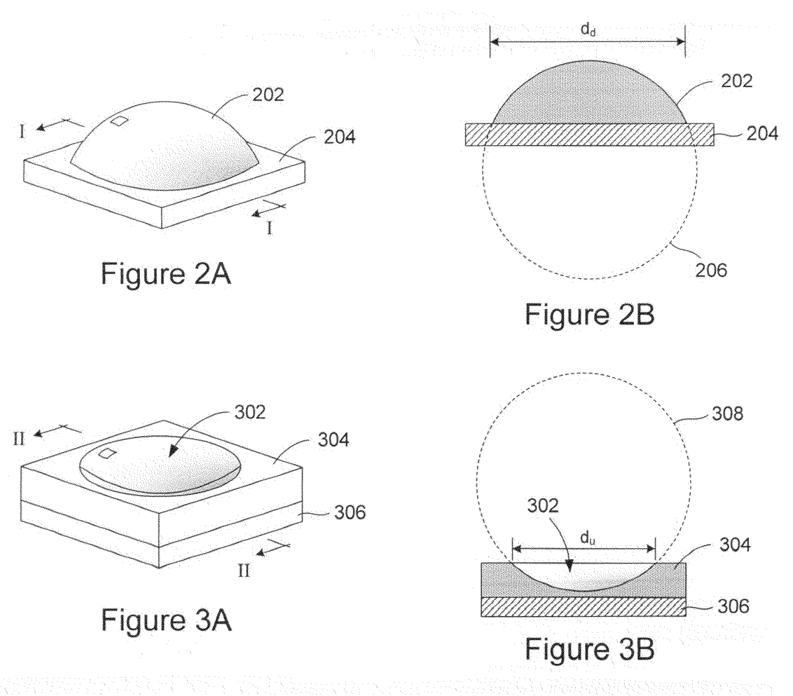

In certain embodiments, the features can be rounded convex protuberances called “convex features.” FIG. 2A shows an isometric view of a convex feature 202 disposed on a substrate 204, and FIG. 2B shows a cross-sectional view of the convex feature 202 along a line I-I, shown in FIG. 2A, in accordance with embodiments of the present invention. Dashed-line circle 206 reveals that the convex feature 202 has a rounded or spherical curvature. In other embodiments, the features can be rounded concave depressions called “concave features.” FIG. 3A shows an isometric view of a concave feature 302 formed in a surface 304 disposed on a substrate 306 in accordance with embodiments of the present invention. FIG. 3B shows a cross-sectional view of the concave feature 302 formed in the surface 304 along a line II-II, shown in FIG. 3A, in accordance with embodiments of the present invention. Dashed-line circle 308 reveals that the concave feature 302 also has a rounded or spherical curvature. In the following description, the term “feature” is a general term used to refer to both convex and concave features.

The diameters d_{d} and dᵤ of the features 202 and 302 shown in FIGS. 2-3 have dimensions on the order of less than about 2 mm, and the density of features forming the reflective surface 100 is on the order of about 100-200 features per square inch or finer. In order to reduce diffraction effects, the diameter of features can be larger than the wavelength of light incident on the reflective surface 100.

Features configured in accordance with embodiments of the present invention have reflective outer surfaces such that each feature exhibits specular reflectance but little if any diffraction of incident light. The features can be composed of a material that produces a reflective mirror-like outer surface, or the outer surface of each feature can be painted with a reflective mirror-like material.

The relatively small dimensions and specular reflectance properties of the features create the appearance to an observer that each feature of the reflective surface 100 reflects incident light off of a single point. In other words, each feature operates as a single pixel such that incident light reflected off of each feature appears to an observer as light reflected off of a single point of the reflective surface 100. Light absorbing paint or ink can be selectively deposited on portions of the outer surface of selected features to block or lessen the amount of light reflected at different angles from the selected features. The term “paint” as used herein, is a general term referring not only to paint but to ink or any other suitable light-absorbing material that adheres to the reflective surface of a feature. The paint or ink is a coating that ideally exhibits non-specular and non-diffractive reflectance properties. The result is a reflective surface that under various lighting conditions or changes in viewing direction creates the appearance that scene content displayed by the reflective surface changes.

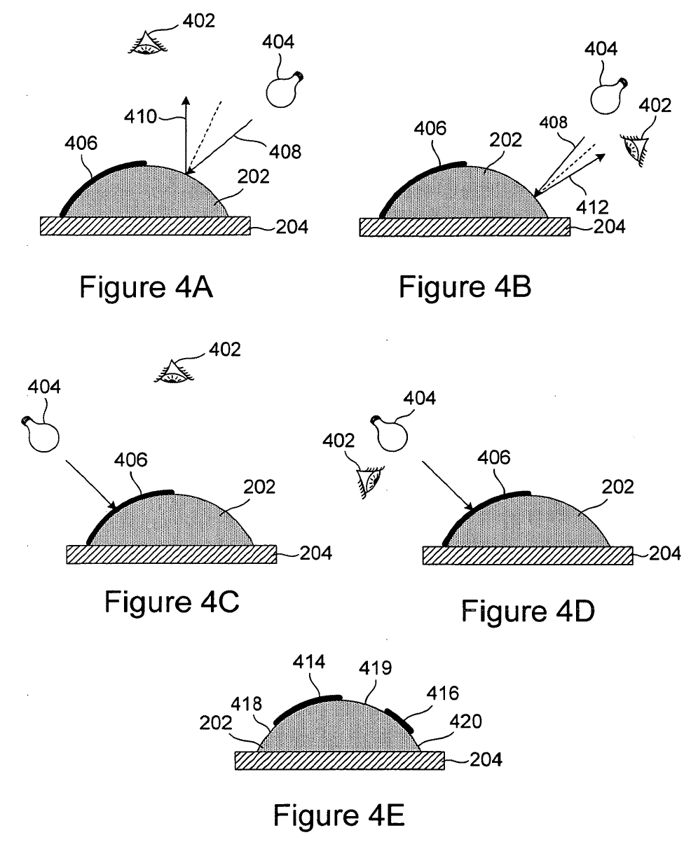

Light incident on an unpainted portion of a feature from one direction is reflected off in multiple directions, and each reflected ray of light can be observed from a different observations point facing the uncoated portion of the feature. In contrast, light incident on a painted portion of the feature is not reflected, and thus reflected light cannot be observed from observation points facing the painted portion of a feature. FIGS. 4A-4E show cross-sectional views of a partially painted convex feature operated in accordance with embodiments of the present invention. In FIGS. 4A-4D, and in subsequent figures, eye 402 represents a fixed observation point or viewing direction, light bulb 404 represents a single point light source from which rays of light emanate, heavy shaded curve 406 disposed on a portion of the outer surface of the convex feature 202 represents paint, ink, or another suitable light-absorbing material that adheres to the outer surface of a feature. Directional arrows, such as directional arrow 408, represent rays of light representing the radiant flow of electromagnetic radiation.

FIGS. 4A and 4B demonstrate that light incident on the unpainted portion of the convex feature 202 in the direction 408 produces reflected rays 410 and 412 that can be observed from above, as shown in FIG. 4A, and can be observed from observation points facing the unpainted side of the convex feature 202, as shown in FIG. 4B. On the other hand, FIGS. 4C and 4D demonstrate that light incident on the paint 406 in the direction 414 is not reflected toward observation points facing the paint 406. FIGS. 4A and 4D also reveal that when the partially painted convex feature 202 is viewed from a fixed observation point located above the convex feature 202, changing the direction of the light source 404 determines whether or not reflected light is observed at the observation point. In particular, reflected light is observed from above for light incident on the unpainted portion of the convex feature 202, as shown in FIG. 4A, but reflected light is not observed from above for light incident on the painted portion of the convex feature 202, as shown in FIG. 4D. Gradually moving the light source from the position shown in FIG. 4B to the position shown in FIG. 4D allows an observer located at the fixed observation point shown in FIG. 4B to observe reflected light until the incident rays of the light source 404 strike the paint 406, after which the observer no longer observes reflected light.

Embodiments of the present invention include applying paint to more than one region of the reflective surface of a feature so that incident light can be selectively reflected and not reflected toward a variety of different observation points. As a result, a selectively painted feature can be included in numerous different images, each of which can be viewed from various observation points and under various lighting conditions. FIG. 4E shows that paint can be selectively applied to more than one region of the outer surface of the convex feature 202 in accordance with embodiments of the present invention. Painted regions 414 and 416 prevent fight from being reflected toward observation points facing painted regions 414-416, and unpainted regions 418-420 between painted regions 414 and 416 allow light to be reflected toward observation points facing the unpainted regions 418-420. As a result, the convex feature 202, painted as show in FIG. 4E, can be implemented in a reflective surface configured to reflect five or more images, all of which can be viewed from various observation points and under various lighting conditions.

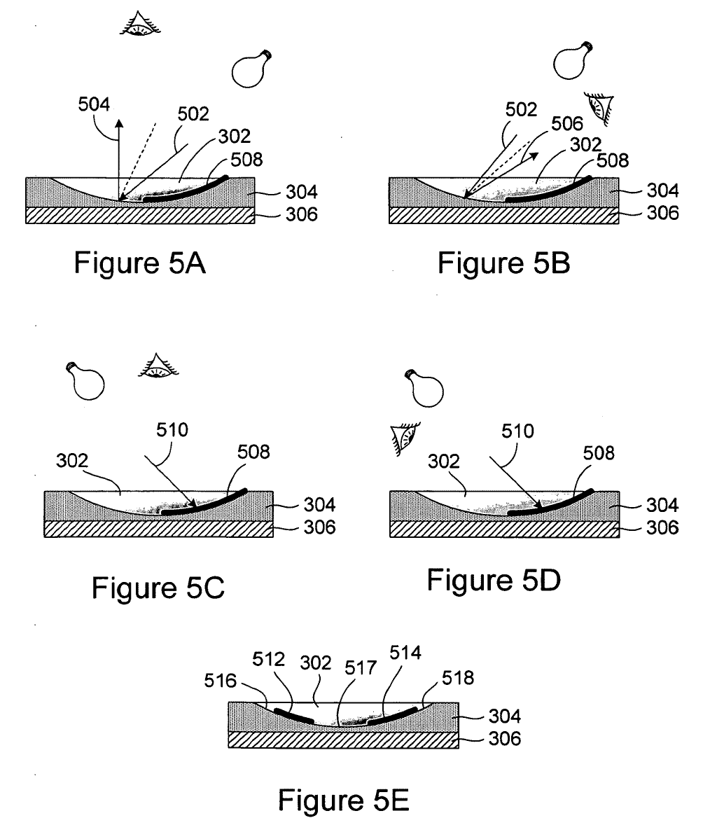

FIGS. 5A-5E show cross-sectional views of a partially painted concave feature operated in accordance with embodiments of the present invention. FIGS. 5A and 5B demonstrate that light incident on the unpainted portion of the concave feature 302 in the direction 502 produces reflected rays of light 504 and 506 that can be observed from above, as shown in FIG. 5A, and can be observed from observation points facing the unpainted side of the concave feature 302, as shown in FIG. 4B. On the other hand, FIGS. 5C and 5D demonstrate that light incident on the paint 508 in the direction 510 is not reflected, and reflected light cannot be observed from from observation points facing the paint 508. FIGS. 5A and 5D also reveal that when the partially painted concave feature 302 is viewed from a fixed observation point located above the concave feature 302, changing the direction of the light source determines whether or not reflected light is observed at the fixed observation point. In particular, reflected light is observed from above for light incident on the unpainted portion of the concave feature 302, as shown in FIG. 5A, but reflected light is not observed from above for light incident on the painted portion of the concave feature 302, as shown in FIG. 5D. Gradually moving the light source from the position shown in FIG. 5B to the lighting position shown in FIG. 5D, allows an observer located at the fixed observation point shown in FIG. 5B to observe reflected light until the incident rays of the light strike the paint 508, after which the observer no longer observes reflected light. FIG. 5E shows that paint can be selectively applied to more than one region of the outer surface of the concave feature 302 in accordance with embodiments of the present invention. Painted regions 512 and 514 prevent light from being reflected toward observation points facing painted regions 512 and 514. Unpainted regions 516-518 allow light to be reflected toward observation points facing the unpainted regions 516-518. Like the convex feature 202, shown in FIG. 4E, the concave feature 302 show in FIG. 5E can be implemented in a reflective surface configured to reflect five or more images that can be viewed from various observation points and under various lighting conditions.

Implementations of the reflective surface 100 are illustrated and described below with reference to convex features. These same embodiments can be implemented with concave features to create the same visual effects described below for convex features. For the sake of simplicity in describing various implementations, perceived changes in the images displayed by a reflective surface are described with respect to a fixed observation point while the direction light impinges on the reflective surface changes. However, the same perceived changes in reflected images can also be perceived by changing the observer's point of view.

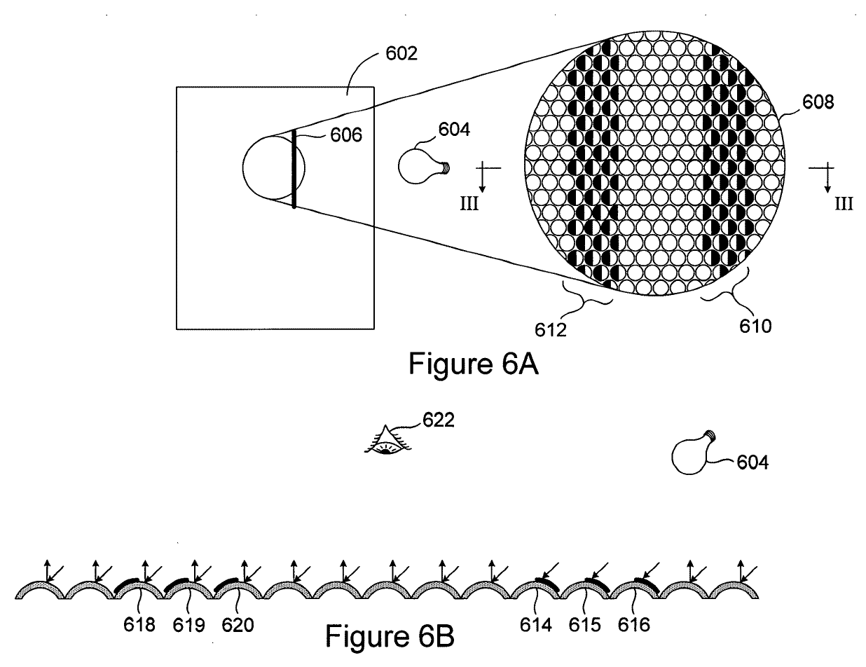

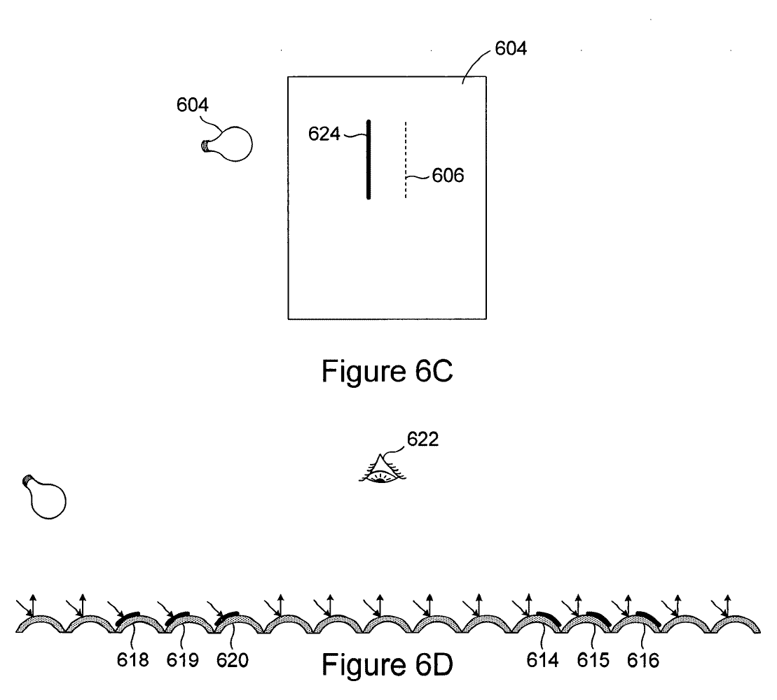

Paint can be selectively applied to particular features of a reflective surface in order to produce multiple images that can each be separately observed from a fixed observation point when the reflective surface is illuminated from different directions. FIGS. 6A-6D show how a reflective surface can be painted to create the appearance of an object changing position in accordance with embodiments of the present invention. FIG. 6A shows a front view of a reflective surface 602 illuminated by a light source 604 located at a first position. Light impinging on the reflective surface 602 from the direction of the light source 604 displays a first thick, black line 606. FIG. 6A also includes a magnified view 608 of the reflective surface 602 revealing painted portions of features 610 corresponding to features of the first line 606 and painted portions of features 612 corresponding to a second line not displayed on the reflective surface 602 for light emanating from the light source 604. FIG. 6B shows a cross-sectional view of a row of convex features along a line III-III, shown in FIG. 6A, in accordance with embodiments of the present invention. The row of convex features includes three partially painted features 614-616 of the first line 606 and three partially painted features 618-620 of the second line. As shown in FIG. 6B, unpainted features reflect light away from the reflective surface 602. The features 618-620 are selectively painted so that light impinging from the direction of the light source 604 is also reflected. In contrast, the features 614-616 are selectively painted so that light impinging from the direction of the light source 604 is absorbed and not reflected creating a portion of the observed first line 606. Thus, an observer viewing the reflective surface 602 from an observation point 622 sees the first line 606 but not the second line because the features, such as features 618-620, associated with the second line reflect light in the same manner as the unpainted features. However, when the light source 604 is repositioned so that light impinges on the reflective surface 604 from a second direction, as shown in FIG. 6C, the second thick, black line 624 is revealed and the first line 602 disappears. A dash-line represents the location of the first line 606 shown in FIG. 6A. As shown in the cross-sectional view of FIG. 6D, unpainted features still reflect light away from the reflective surface 602. The painted portions of the features 618-620 now absorb light incident from the repositioned light source 604 creating a portion of the observed second line 624. Light impinging from the repositioned light source 604 is reflected off of the unpainted surface portions of the features 614-616. Thus, an observer viewing the reflective surface 604 from the observation point 622 sees the second line 624 but not the first line 606 because the features 614-616 associated with the first line 606 reflect light in the same manner as the unpainted features.

FIGS. 6A-6D reveal that an observer viewing the reflective surface 604 from a fixed observation point perceives a change in the position of a single line when the direction at which light is incident on the surface 604 is changed. This same visual effect can be observed when light simultaneously impinges on the surface 604 from several different directions but the observation point is accordingly changed.

Paint can also be selectively applied to particular features of a reflective surface to create three-dimensional visual effects. Black and white three-dimensional objects can be created by dithering a pattern of black paint on selected features in order to achieve a grey-scale appearance. Dithering is a technique that can be used to create the illusion of depth in images with a limited color palette. In a dithered image, colors not available in the palette, such as grey in a black and white patette, are approximated by a diffusion of colors from within the available palette. An observer perceives the diffusion as a mixture of the colors.

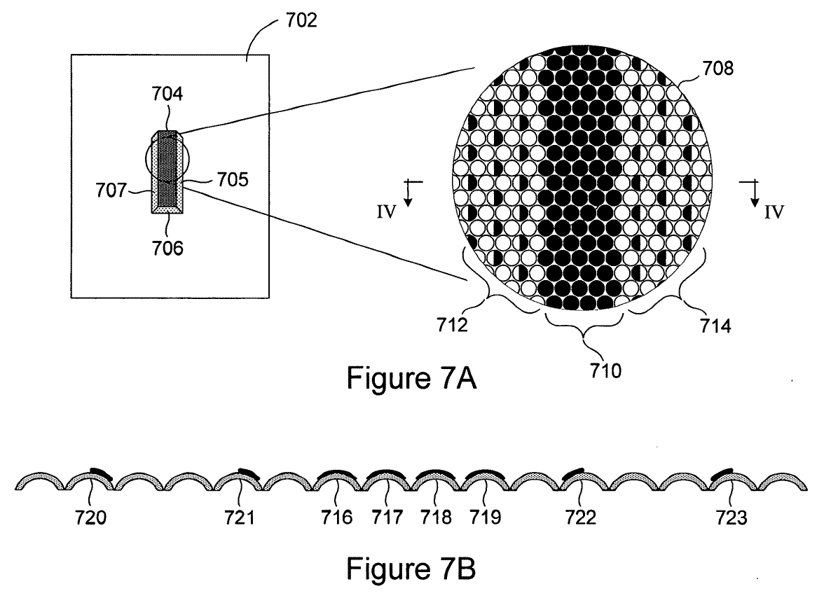

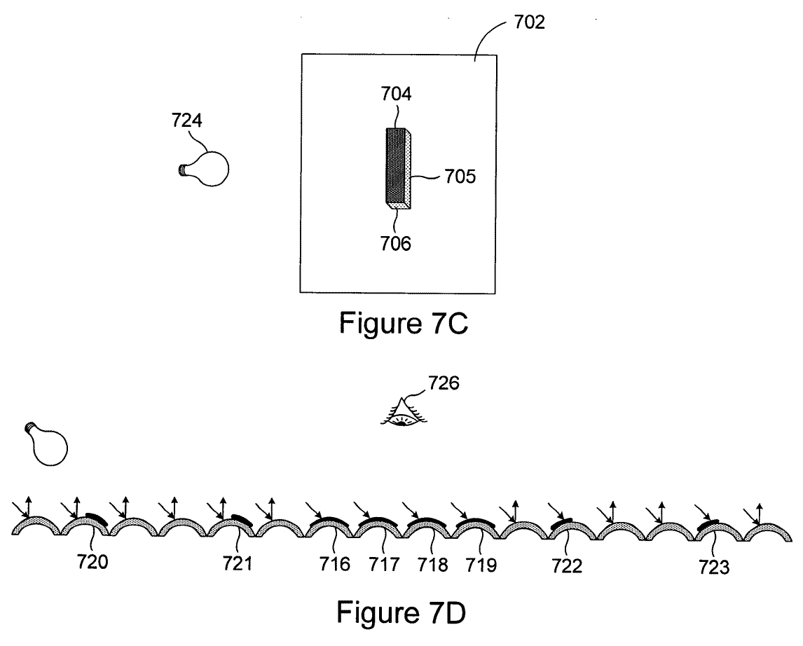

FIGS. 7A-7D show how dithering can be applied to a reflective surface to create the appearance of a three-dimensional image in accordance with embodiments of the present invention. FIG. 7A shows a front view of a reflective surface 702. A simple rectangle of dark features 704 represents a front surface of a bar, and lightly shaded regions 705-708 surrounding three sides the bar 704 represents dithered regions used to create a three-dimensional or shadow effect for light impinging on the reflective surface 702 from different directions. FIG. 7A also includes a magnified view 708 of the reflective surface 702 revealing painted features 710 corresponding to the bar 704 and selectively painted portions of features 712 and 714 corresponding to features in the dithered regions 707 and 705, respectively. FIG. 7B shows a cross-sectional view of a row of convex features along a line IV-IV, shown in FIG. 7A, in accordance with embodiments of the present invention. The row of convex features includes four painted features 716-719 corresponding to a row of painted features in the bar 710, partially painted features 720 and 721 corresponding to partially painted features in the dithered region 712, and partially painted features 722 and 723 corresponding to partially painted features in the dithered region 714. FIG. 7C shows a front view of the reflective surface 702 illuminated from a first direction by a light source 724. Light impinging on the reflective surface 702 displays the bar 704 and a shadow region located on the opposite side of the bar 704 from the position of the light source 724. The shadow region is created by light impinging on painted and unpainted portions of features in the dithered regions 705 and 706. FIG. 7D reveals that unpainted features in the row of convex features shown in FIG. 7B reflect light away from the reflective surface 702. The features 720 and 721 are selectively painted so that light impinging from the direction of the light source 724 is reflected resulting in no reduction in the amount of reflected light. In contrast, the features 716-719, 722, and 723 are selectively painted so that light impinging from the direction of the light source 724 is absorbed-by painted features 716-719 of the bar 704 and by certain features 722 and 723 of the dithered region 705. An observer viewing the reflective surface 702 from the observation point 726 sees the bar 704 and perceives a grey shadow region created by a reduction in the amount of reflected light from features in the dithered regions 705 and 706.

Embodiments also include dithering individual features so that dithering can be used to create a grey-scale effect for images displayed by the same set features but viewed from different points of observation. For example, each feature in a set of features can be selectively painted, as described above with reference to FIGS. 4E and 5E, such that a first dithered image displayed by the set of features can be viewed from a first point of observation and a second dithered image displayed by the same set of features can be viewed from a second observation point and/or under a different lighting arrangement.

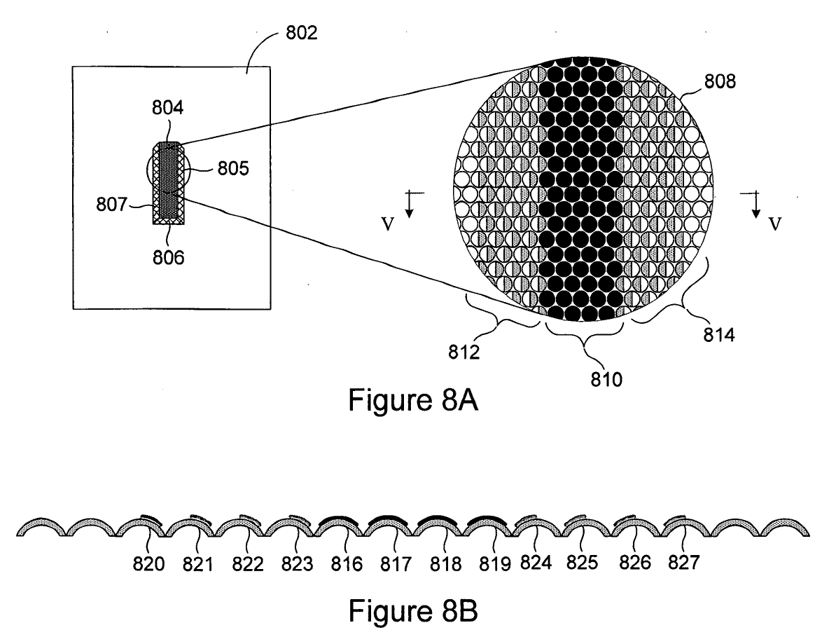

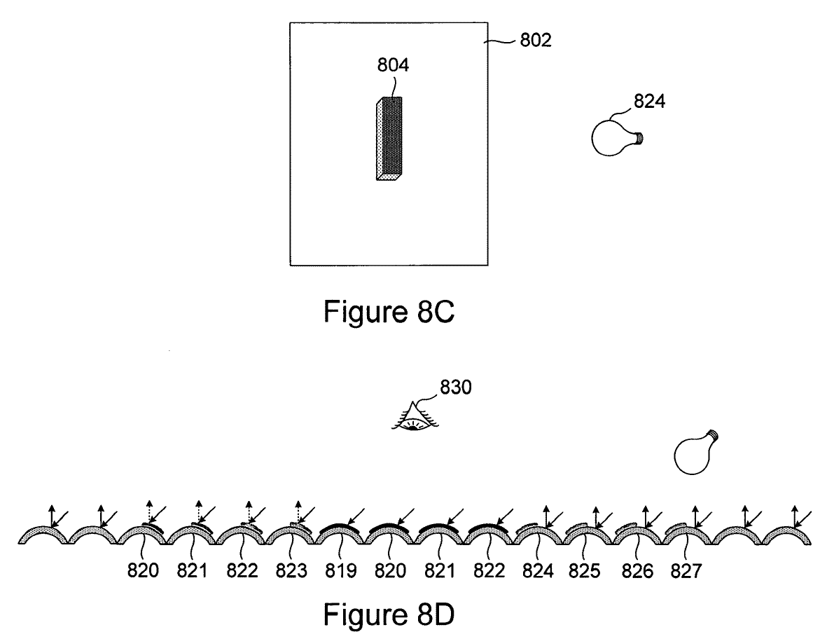

In other embodiments, semitransparent paints ranging from opaque to substantially translucent can be selectively applied to the features of a reflective surface in order to provide a grey-scale that can be used to create three-dimensional visual effects. FIGS. 8A-8D show semitransparent paint applied to a reflective surface to create the perception of a three-dimensional image in accordance with embodiments of the present invention. FIG. 8A shows a front view of a reflective surface 802. A rectangle of dark features 804 represents a front surface of a bar and hash-marked regions 805-808 adjacent to three sides the bar 804 represents features painted with a semitransparent paint to create a three-dimensional or shadow effect for light impinging on the reflective surface from different directions. FIG. 8A also includes a magnified view 808 of the reflective surface 802 revealing features 810 painted with paint corresponding to the bar 804 and partially painted features 812 and 814 painted with a semitransparent paint. FIG. 8B shows a cross-sectional view of a row of convex features along a line V-V, shown in FIG. 8A, in accordance with embodiments of the present invention. The row of convex features includes four features 816-819 painted with a light absorbing paint corresponding to a row of painted features of the bar 804, features 820-823 partially painted with semitransparent paint correspond to a row of features in region 812, and features 822-827 partially painted with semitransparent paint correspond to a row of features in region 814. FIG. 8C shows a front view of the reflective surface 802 illuminated by a single point light source 824. Light impinging on the reflective surface 802 displays the bar 804 and a shadow region located on the opposite side of the bar 804 from the position of the light source 824. The shadow region is created by light impinging on the semitransparent paint painted on portions of features in the regions 807 and 806. FIG. 8D reveals that unpainted features in the row of convex features shown in FIG. 8B reflect light away from the reflective surface 802. The features 820-823 are selectively painted with semitransparent paint so that only a portion of the light impinging from the direction of the light source 824 is reflected as represented by dotted-line directional arrows. In contrast, the features 819-822 absorb incident light, and the features 824-827 are selectively painted so that light impinging from the direction of the light source 824 is reflected by unpainted surfaces. An observer viewing the reflective surface 802 from the observation point 830 sees the bar 804 and the partially reflected light reflected from shadow regions 806 and 807 creates a visual shadow effect.

The three-dimensional image effects created in FIGS. 8A-8D are accomplished with non-specular and non-diffractive light absorbing paint and specular and non-diffractive semitransparent paint. But other embodiments of the present invention include semitransparent paints that absorb and reflect different portions of incident light. The cumulative visual effect of each of these semitransparent paints is the reflection of a different shade of grey that can each be used to represent various light and dark shadows in three-dimensional, black-and-white images or three-dimensional black-and-white images that appear to move or change as the incident lighting angle is changed or as an observer's observation point is changed.

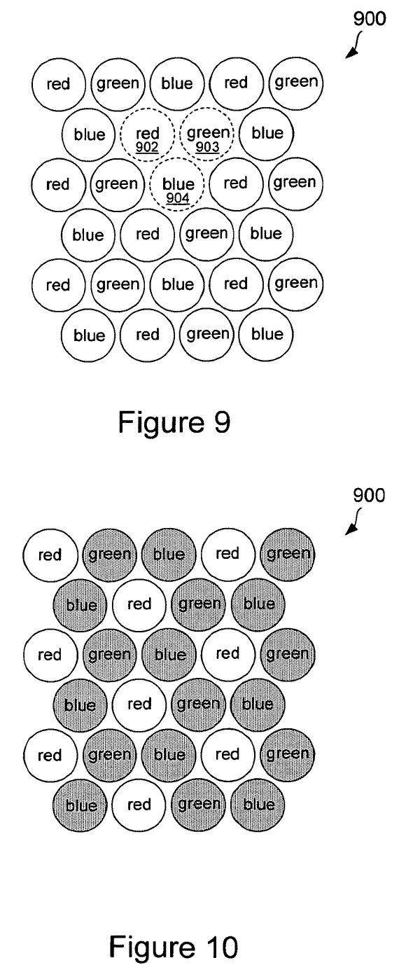

Reflective surface embodiments can also be configured to provide full-color images under different lighting conditions by configuring each feature within a triad of features to reflect one of the three primary colors: red, green, and blue. The primary colors are used because nearly all other colors in the visible color spectrum can be created from these three hues. FIG. 9 shows a front-view of multiple features 900 of a full-color reflective surface configured in accordance with embodiments of the present invention. As shown in FIG. 9, each feature is labeled with the color that each feature reflects upon illumination. For example, each of the features comprising the triad of dashed-line features 902-904 reflects one of the primary colors.

A full-color reflective surface can be configured to reflect exclusively one of the three primary colors by painting over the features that reflect the other two primary colors. For example, FIG. 10 shows shaded blue and shaded green features represent painted over blue and green features of the multiple features 900 in accordance with embodiments of the present invention. As a result, the “red” labeled features reflect red light when light impinges on the multiple features 900.

Dithering the features of a full-color reflective surface also enables mixing of various combinations of the three primary colors to produce a variety of different colors. Dithering can be carried out so that an observer perceives certain colors when light is incidnet on the multiple features in one direction and preceives different colors when light is incidnet on the multiple features in another direction.

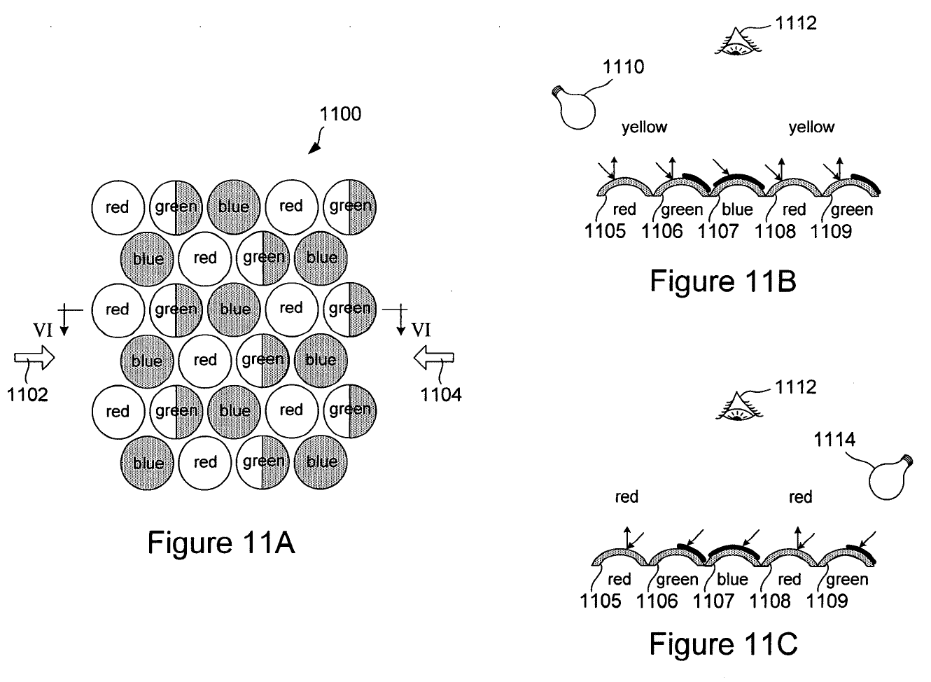

FIG. 11A shows multiple features 1100 selectively painted to reflect yellow light for light incident from a first direction and red light for light incident from a second direction in accordance with embodiments of the present invention. In FIG. 11A, the features reflecting blue light are painted over, the features reflecting red light are not painted over, and substantially one-half of the outer surface area of each of the features reflecting green light are painted over. For light incident on the multiple features 1100 from a first direction 1102, the uncovered portion of the features reflecting green light mixes with the adjacent features reflecting red light to produce yellow light. For light incident on the multiple features 1100 from a second direction 1104, only the uncovered features reflect red light. FIGS. 11B-11C show cross-sectional views of a row of features 1105-1109 along a line VI-VI, shown in FIG. 11A, configured in accordance with embodiments of the present invention. In FIG. 11B, for light impinging on features 1105-1109 from the direction of the light source 1110, features 1105 and 1108 reflect red light, the uncovered portions of features 1106 and 1109 reflect green light, and painted over feature 1107 reflects substantially no light. An observer viewing the multiple features 1100 from an observation point 1112 perceives yellow light, which results from mixing the red and green light reflected from adjacent red and green reflecting features, such as adjacent red and green reflecting features 1105 and 1106 and adjacent red and green reflecting features 1108 and 1109. In FIG. 11C, for light impinging on features 1105-1109 from the direction of the light source 1114, the painted over portions of features 1106 and 1109 and painted over feature 1103 reflect substantially no light leaving the unpainted features 1105 and 1108 to reflect red light alone. An observer viewing the multiple features 1100 from the observation point 1110 sees only the reflected red light.

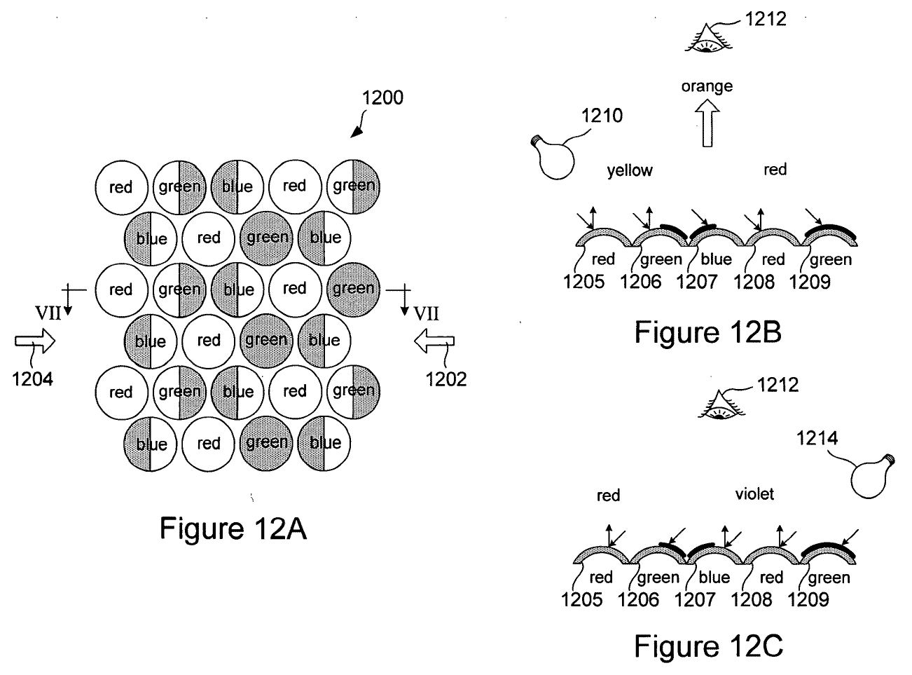

Embodiments also include selectively dithering certain features to create further mixing of colors in order to produce other colors reflected from a full-color reflective surface. FIG. 12A shows multiple features 1100 selectively painted to reflect violet light for light incident from a first direction and orange light for light incident from a second direction in accordance with embodiments of the present invention. In FIG. 12A, substantially one-half of the outer surfaces of the features reflecting blue light are painted over, and the features reflecting red light are not painted over. The features reflecting green light are divided into a first portion with the outer surface area nearly fully painted over, and a second portion with substantially one-half of the outer surface area painted over. For light incident on the multiple features 900 from a first direction 902, the blue light reflected off of the uncovered portion of the features reflecting blue light mixes with the red light reflected off of features reflecting red light to produce a perceived violet light. For light incident on the multiple features 900 from a second direction 904, the nearly fully painted over features reflecting green light allow more red light to mix with the yellow light reflected from adjacent features reflecting green and red light to produce a perceived orange light. FIGS. 12B-12C show cross-sectional views of a row of features 1205-1209 along a line VII-VII, shown in FIG. 12A, configured in accordance with embodiments of the present invention. In FIG. 12B, for light impinging on features 1205-1209 from the direction of the light source 1210, features 1205 and 1208 reflect red light, the uncovered portions of feature 1206 reflect green light, and painted over features 1207 and 1209 reflect substantially no light. An observer viewing the multiple features 900 from an observation point 1212 perceives orange light resulting from mixing yellow reflected light from adjacent features 1205 and 1206 with the red light reflected from feature 1208. In FIG. 12C, for light impinging on features 1205-1209 from the direction of the light source 1214, the painted over portions of features 1206 and 1209 reflect substantially no light leaving the unpainted portions of features 1205, 1207, and 1208 to reflect red and blue light. An observer viewing the multiple features 1200 from the observation point 1212 perceives violet light, which is a mixing of the reflected red and blue light.

FIGS. 9-12 reveal that an observer viewing a full-color reflective surface from a fixed observation point perceives a change in color when the light incident on the surface is changed. This same effect can be observed when light impinges on the surface from several different directions and the observation point is accordingly changed.

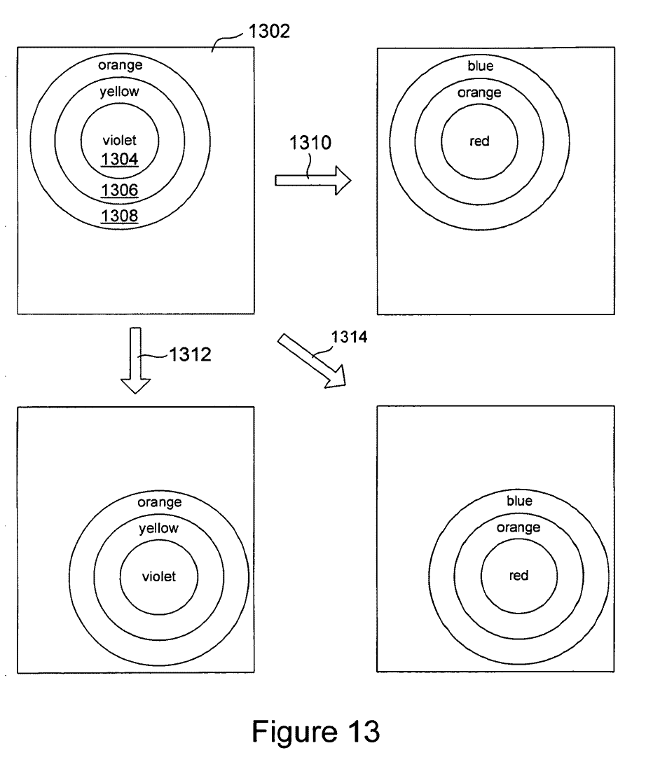

FIG. 13 shows how a full-color reflective surface 1302 can be configured to produce a color change, movement, or color change and movement in accordance with embodiments of the present invention. As shown in FIG. 13, a full-color reflective surface 1302 is configured to reflect an image of violet colored circle 1304 surrounded by a yellow colored annular region 1306 which is surrounded by a larger orange colored annular region 1308 when the surface 1302 is illuminated from a first direction or when the surface 1302 is observed from a first observation point. In certain embodiments, as indicated by directional arrow 1310, the features can be painted so that the circle 1304 and the annular regions 1306 and 1308 reflect red, orange, and blue colors, respectively, when the surface 1302 is illuminated from a second direction or when the surface 1302 is observed from a second observation point. In other embodiments, as indicated by directional arrow 1312, the features of the surface 1302 can be painted so that the circle 1304 and the annular regions 1306 and 1308 appear to move to a different location when the surface 1302 is illuminated from a second direction or when the surface 1302 is observed from a second observation point. In still other embodiments, as indicated by directional arrow 1314, the features of the surface 1302 can be painted so that the circle 1304 and the annular regions 1306 and 1308 change colors and appear to move to a different location within the surface 1302 when the surface 1302 is illuminated from a second direction or when the surface 1302 is observed from a second observation point.

The primary colors can be combined to produce a useful range of colors by making additive combination of colors, such as reflecting red and green light from adjacent features to obtain the perception of yellow light. However, full-color reflective surface embodiments are not limited to the primary colors. For example, in other embodiments, the features comprising a triad of features can be composed of magenta, cyan, and yellow.

Applications for reflective surface embodiments of the present invention include and are not limited to displaying illustrations, photographs, posters, novelty items, and billboards. For example, an image displayed on a billboard with a reflective surface can appear to vary as an observer changes his/her view of the billboard because the effective lighting direction with respect to a light source relative to the observer is changing. Photographs, posters, novelty items, and billboards can be configured to display short motion pictures.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A reflective surface comprising:
a substrate; and
multiple light-reflecting features disposed on the substrate, wherein one or more images reflected from the multiple features can be produced by selectively covering at least portions of select features with a light absorbing material.

2. The surface of claim 1 wherein each image reflected from the multiple features can be separately viewed by varying an observer's point of observation or each image can be viewed from a fixed observation point by varying the direction incident light impinges the surface.

3. The surface of claim 1 wherein a unit cell of the multiple features disposed on the substrate further comprises a triangular arrangement of three adjacent features.

4. The surface of claim 1 wherein the multiple features further comprise one of:
convex protuberances; and
concave depressions.

5. The surface of claim 1 wherein the light absorbing material further comprises one of:
an opaque material; and
a semitransparent material.

6. The surface of claim 4 wherein the opaque material further comprises paint, ink, or another suitable light-absorbing material that adheres to the outer surface of a feature and has substantially non-specular and non-diffractive reflectance properties.

7. The surface of claim 1 wherein the material further comprises a translucent material.

8. The surface of claim 1 wherein each feature of the multiple features further comprises a pixel.

9. The surface of claim 1 wherein a triad of the multiple features further comprises a pixel wherein each feature in the triad reflects one of three different color.

10. The surface of claim 8 wherein each feature in the triad reflects one of three different color further comprises one feature reflecting red light, one feature reflecting blue light, and one feature reflecting green light.

11. The surface of claim 1 wherein each feature further comprises a diameter of less than about 2 mm and the multiple features further comprise a density of about 100-200 features per square inch or finer.

12. The surface of claim 1 wherein each feature of the multiple features further comprises an outer surface having specular and non-diffractive optical properties.

13. A billboard having a reflective surface configured in accordance with claim 1 to display one or more images.

14. A photograph having a reflective surface configured in accordance with claim 1 to display one or more images.

15. A novelty item having a reflective surface configured in accordance with claim 1 to display one or more images.

16. A method for viewing multiple images comprising:
providing a reflective surface configured in accordance with claim 1;
selecting features to reflect an image toward an observation point; and
selectively applying a light absorbing material to features of the reflective surface such that light impinging on the reflectance surface is reflected so that the image can be viewed from the observation point.

17. The method of claim 16 wherein features further comprise one of:
convex protuberances; and
concave depressions.

18. The method of claim 16 wherein selectively applying a light absorbing material to features further comprises applying the light absorbing material to portions of features in order to block the reflection of light toward the observation point.

19. The method of claim 16 wherein selectively applying a light absorbing material to features further comprises applying the light absorbing material to portions of one or more features in a triad of color reflecting features in order to enable mixing of unblocked reflected light to be perceived at the observation point.

20. The method of claim 16 wherein in the image further comprises one of:
a full-color image; and
a black and white image.
